(19) United States
(12) Patent Application Publication
(10) Pub. No.: US 2002/0099966 A1
(43) Pub. Date: Jul. 25, 2002

(54) Method and apparatus for waking up a circuit and applications thereof

(75) Inventor: Carlin D. Cabler, Austin, TX (US)

Correspondence Address: Sigma Tel, Inc., Suite 300, 3815 S. Capital of Texas Hwy., Austin, TX, 78704, US

(73) Assignee: SigmaTel, Inc.

(21) Appl. No.: 09/769,543

(22) Filed: Jan. 25, 2001

(51) Int. Cl. G06F 1/26; G06F 1/28; G06F 1/30

(52) U.S. Cl. 713/323

(57) ABSTRACT

A method and apparatus for waking up a circuit includes processing that begins by determining whether a signal is present on a data path by a 1^{st} detection module. The 1^{st} detection module is designed with passive components such that it consumes a minimal amount of power. In addition, the 1^{st} detection module detects the presence of any signal on the received path using the energy of the signal. When a signal is detected, a 2^{nd} detection module is enabled to determine whether a characteristic of the signal is one of a known set of characteristics. The known set of characteristics includes a phase relationship, magnitude, power level, frequency, and/or any other characteristic a telecommunication system may have. When the characteristic of the signal is one of the known set of characteristics, the digital circuitry of a modem is enabled.

### TECHNICAL FIELD OF THE INVENTION

This invention relates generally to telecommunications and in particular to telecommunication analog front-ends.

### BACKGROUND OF THE INVENTION

Telecommunication modems are known to include an analog front-end and data protocol processing circuitry. The data protocol processing circuitry processes received data (i.e. upstream data), and transmit data (i.e. downstream data) with a central office. The functionality of the data transmission protocol circuitry is dependent upon the data transmission protocol being implemented. For example, the data transmission protocol may be asymmetrical digital subscriber line (ADSL), universal asymmetrical digital subscriber line (UADSL), high-speed digital subscriber line (HDSL), symmetrical high-speed digital subscriber line (SHDSL), asynchronous transfer mode (ATM), Internet protocol (IP), et cetera.

The analog front-end is the interface between the transmission channel, for example, the telephone lines and the transmission lines. Typically, an analog front-end will include a receive path circuitry and transmit path circuitry. Receive path circuitry will include filtering and an analog to digital converter. The transmit path will include a digital to analog converter, a filter, and a line driver. The analog portion of the analog front-end is operably coupled to the transmission line while the digital portions are operably coupled to the data transmission protocol circuitry.

Rarely is a telecommunication modem continually used. Accordingly, most telecommunication modems include wakeup circuitry such that when the modem is not in use, the digital portions are in an idle state (i.e. off), until the modem is needed. Typically, the wakeup circuitry will monitor the analog receive input on the transmission line to determine whether the signal strength of an incoming signal exceeds a particular threshold. When the threshold is exceeded, the digital portions of the modem are awakened (i.e. become active) to determine whether the signal on the receive path is a valid signal. For example, in ADSL or SHDSL, two training sequences occur. The 1^{st} is a pre-training sequence, which utilizes differential quadrature phase shift keying (DQPSK) to initiate a valid communication. As such, when the digital circuitry of the modem is awakened, it is determining whether the incoming signals correspond to a valid training sequence.

In such wakeup circuits, the wakeup circuit is still required to receive power such that it may detect the incoming signal. As such, while the power is reduced by disabling the digital circuitry, power is still consumed by the wakeup circuitry. In portable electronic devices, is conserving as much power is possible is an ever increasing design goal.

Therefore, a need exists for a method and apparatus of waking up the circuit, which consumes minimal power to detect the presence of incoming signals.

### BRIEF DESCRIPTION OF THE DRAWINGS

FIG. 1 illustrates a schematic block diagram of an analog front-end in accordance with the present invention;

FIG. 2 illustrates a schematic block diagram of an alternate analog front-end in accordance with the present invention;

FIG. 3 illustrates a graphical representation of an analog receive signal in accordance with the present invention;

FIG. 4 illustrates a schematic block diagram of a multi-stage wakeup circuit in accordance with the present invention;

FIG. 5 illustrates a schematic block diagram of an apparatus for waking up a circuit in accordance with the present invention; and

FIGS. 6 through 9 illustrate a logic diagram of a method for waking up a circuit in accordance with the present invention.

### DETAILED DESCRIPTION OF A PREFERRED EMBODIMENT

Generally, the present invention provides a method and apparatus for waking up a circuit. Such a method and apparatus includes processing that begins by determining whether a signal is present on a data path by a 1^{st} detection module. The 1^{st} detection module is designed with passive components such that it consumes a minimal amount of power. In addition, the 1^{st} detection module detects the presence of any signal on the received path using the energy of the signal. When a signal is detected, a 2^{nd} detection module is enabled to determine whether a characteristic of the signal is one of a known set of characteristics. The known set of characteristics includes a phase relationship, magnitude, power level, frequency, and/or any other characteristic a telecommunication system may have. When the characteristic of the signal is one of the known set of characteristics, the digital circuitry of a modem is enabled. With such a method and apparatus, minimal to negligible power is consumed by a wakeup circuit until a signal is detected on the received path.

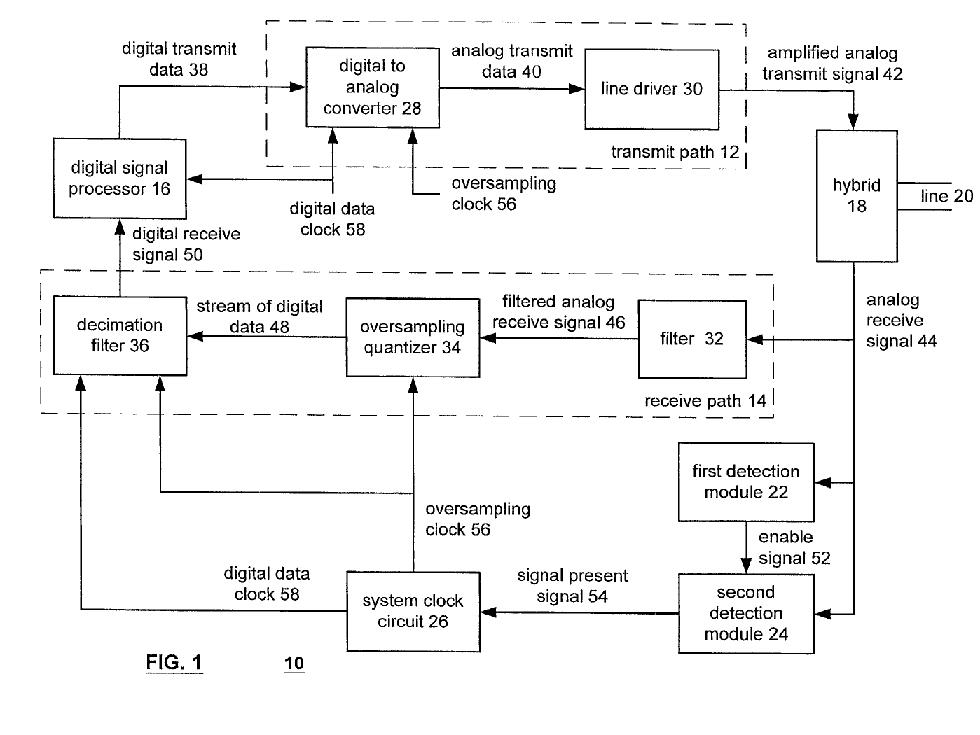

The present invention can be more filly described with reference to FIGS. 1 through 9. FIG. 1 illustrates a schematic block diagram of an analog front-end 10 that is operably coupled to a hybrid 18. The hybrid 18 provides an interface between a transmission line 20 and the analog front-end 10. As is known, a hybrid isolates transmission signals from received signals, which are transceived via line 20.

The analog front-end 10 includes a transmission path 12, a received path 14, a digital signal processor 16, a system clock circuit 26, and a wakeup circuit that includes a 1^{st} detection module 22 and a 2^{nd} detection module 24. The transmit path 12 includes a digital to analog converter 28 and a line driver 30, and may also include a filter coupled between the digital to analog converter 28 and the line driver 30. The receive path 14 includes a filter 32, an over-sampling quantizer 34, and a decimation filter 36. The combination of the over-sampling quantizer 34 and the decimation filter 36 form an analog to digital converter.

In operation, the analog front-end 10 starts off in an idle state. In an idle state, the system clock circuit 26 is disabled such that no clock signals are produced for the analog front-end. As a result, all digital circuitry within the analog front-end 10 is disabled. In addition, the analog power source may be disabled from all of the circuitry within the analog front-end as well. As such, in the idle state, the analog front-end is consuming no power.

While in the idle state, the 1^{st} detection module 22 senses an analog received signal 44. When the analog received signal 44 has an amplitude that exceeds a particular threshold, the 1^{st} detection module produces an enable signal 52. Upon producing the enable signal 52, the 2^{nd} detection module 24 is enabled. The 2^{nd} detection module 24 further analyzes the analog received signal 44 to determine whether at least one characteristic of the analog receive signal is one of a known set of characteristics. The known set of characteristics include phase, frequency, amplitude, energy level, and/or any other characteristic that a telecommunication signal may have.

If the 2^{nd} detection module 24 determines that the analog receive signal 44 has at least one characteristic of the known set of characteristics, the 2^{nd} detection module 24 generates a signal present signal 54. The system clock circuit 26 is operably coupled to receive the signal present signal 54 and to generate an over-sampling clock 56 and a digital data clock 58. Once the digital data clock 58 and over-sampling clock 56 are enabled, the digital circuitry of the analog front-end is enabled. Accordingly, the filter 32 receives the analog receive signal 44 and produces therefrom a filtered analog receive signal 46. The over-sampling quantizer 34 receives the filtered analog receive signal 46 and produces a stream of digital data 48. The stream of digital data 48 is at a rate corresponding to the over-sampling clock 56. The decimation filter 36 is operably coupled to receive the stream of digital data 48 and to produce a digital receive signal 50.

The digital signal processor 16 receives the digital receive signal 50 and processes it according to a data transmission protocol. During the startup phase, the digital receive signal will correspond to a training sequence for the corresponding data transmission protocol. For example, in ADSL or SHDSL, the training sequence may utilize differential quadrature phase shift keying. As such, the digital signal processor is determining whether the digital receive signal 50 is a valid training sequence.

Once the digital signal processor 16 determines that the digital receive signal 50 corresponds to a valid training sequence, the digital signal processor 16 produces digital transmit data 38 in accordance with the data transmission protocol. The digital to analog converter 28 is operably coupled to receive the digital transmit data 38 at the digital data clock rate 58 and to produce an analog transmit data 40. The line driver 30 is operably coupled to receive the analog transmit data 40 and to produce an amplified analog transmit signal 42 thereof. The hybrid circuit 18 is operably coupled to provide the amplified analog transmit signal 42 onto the line and to receive the analog receive signal 44 from the line 20.

The 1^{st} detection module 22 may, upon detecting the presence of the analog of a signal on the receive input, may also produce an analog power-on signal. The analog power-on signal would then be utilized to provide power to the analog components within the analog front-end 10. Alternatively, the analog power-on signal may be generated by the 2^{nd} detection module 24 and produced when the signal present signal 54 is produced.

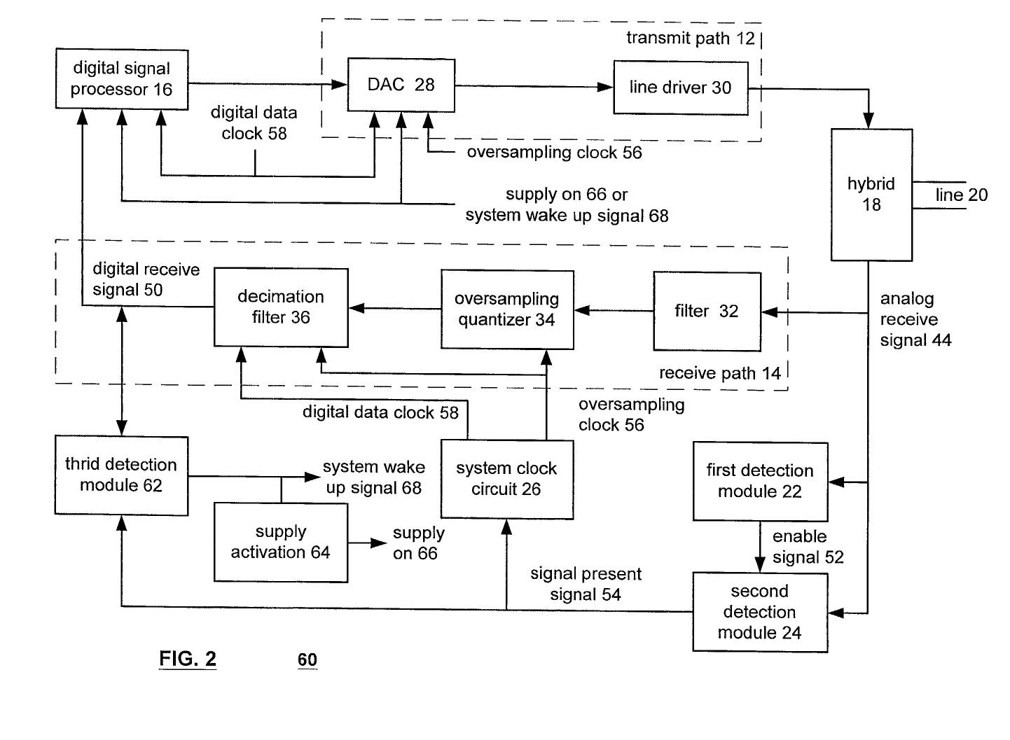

FIG. 2 illustrates a schematic block diagram of an alternate analog front-end 60 that is operably coupled to hybrid 18. The analog front-end 60 includes the transmit path 12, the receive path 14, the digital signal processor 16, the system clock circuit 26 and a wakeup circuit that includes a 1^{st} detection module 22, a 2^{nd} detection module 24, a 3^{rd} detection module 62 and a supply activation module 64. In this embodiment, the analog front-end 60 from the idle state, has all of the analog and digital circuitry disabled such that negligible power is consumed. The 1^{st} detection module 22 is operably coupled to detect the presence of a signal on the receive line. If the 1^{st} detection module 22 detects the presence of a signal, it produces an enabled signal 52. The 2^{nd} detection module 24, based on the assertion of the enable signal 52, determines whether the signal on the receive input has a characteristic that is within a known set of characteristics. If so, the 2^{nd} detection module 24 generates the signal present signal. At this point, the system clock circuit 26 generates the digital data clock 58 and the over-sampling clock 56. However, the digital signal processor 16 and the digital to analog converter 28 remain idle. The over-sampling quantizer 34 and the decimation filter 36 are enabled.

By enabling the over-sampling quantizer 34 and the decimation filter 36, the digital receive signal 50 may be produced from the analog receive signal 44. The 3^{rd} detection module 62 is enabled based on the signal present signal 54 and receives the digital receive signal 50. The 3^{rd} detection module 62 determines whether the digital receive signal 50 is a particular type of signal. For example, if the data transmission protocol is ADSL or SHDSL, the 3^{rd} detection module 62 is determining whether the digital receive signal is the receive path pre-training signal in accordance with the SHDSL or ADSL protocol. If so, the 3^{rd} detection module 62 produces a system wakeup signal 68. The system wakeup signal 68 enables the digital signal processor 16 and the digital to analog converter 28. At this point, the analog front-end is fully enabled.

In addition, the supply activation signal 64 senses the system wakeup signal 68 and produces a supply-on signal 66. the supply-on signal 66 may be provided to further digital processing upstream within the modem to enable the further digital processing of the modem, or used within the analog front-end. As shown, the digital signal processor 16 and the digital to analog converter 28 may be enabled based on the supply-on signal or the system wakeup signal 68. Alternatively, the supply activation module 64 may be triggered based on the signal present signal 54 as opposed to the system wakeup signal 68.

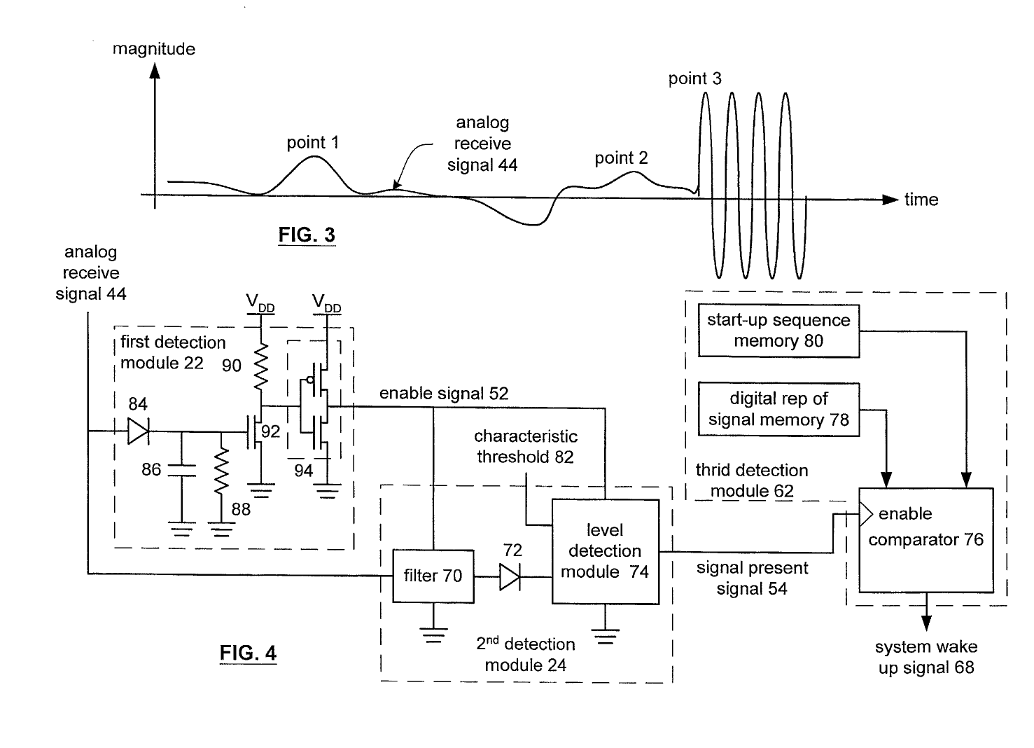

FIG. 3 illustrates a graphical representation of the analog receive signal 44. The graphical representation clocks the analog receive signals magnitude over time. As shown, the analog receive signal 44 includes noise up until a point where a signal present signal is being generated. The signal present signal may correspond to a pre-training sequence in an SHDSL or ADSL system. The noise component of the analog receive signal 44 corresponds to noise on the transmission lines within a SHDSL or ADSL system.

FIG. 4 illustrates a schematic block diagram of the 1^{st} detection module 22, the 2^{nd} detection module 24, and the 3^{rd} detection module 62. As shown, the 1^{st} detection module 22 includes a diode 84, which may be a Schotky diode such that it has a low forward voltage drop, a capacitor 86, a 1^{st} resistor 88, 2^{nd} resistor 90, a 1^{st} transistor 92 and an inverter 94. The inverter 94 includes a p-channel transistor and a n-channel transistor. In operation, the 1^{st} detection module 22 receives the analog receive signal 44. If the analog receive signal 44 has a magnitude that exceeds the voltage drop across diode 84, capacitor 86 receives a charge. Resistor 88 is of sufficient size to slowly dissipate the charge in capacitor 86. If the charge in capacitor 86 produces a voltage equal to the threshold voltage of transistor 92, the transistor 92 is enabled. With transistor 92 enabled, the input to inverter 94 is low such that the output is high thereby producing the enable signal 52. In this configuration, the only power consumed while the analog front-end is in an idle state is based on the impedance of resistor 90 and the on-resistance of the n-channel transistor in the inverter 94.

An alternate embodiment of the 1^{st} detection module 22 removes the n-channel transistor of inverter 44 and adds a resister coupled to the source of the p-channel transistor of inverter 94. In this embodiment, the enable signal 52 is held low by the resistor until transistor 92 is enabled. In this configuration, no energy or negligible energy is consumed.

Referring gently to FIGS. 3 and 4, the 1^{st} detection module 22 senses the analog receive signal 44. At point 1, the magnitude of the analog receive signal 44 is sufficient to cause the 1^{st} detection module 22 to produce the enable signal 52. As shown, the enable signal 52 couples the filter 70, and the level detection module 74 of the 2^{nd} detection module 24 to the analog supply voltage (V_{dd}). The type of filtering performed by filter 70 is dependent upon the particular type of data path and the signal bandwidth characteristics. For example, the data path may be a base-band wireless communication path, a pass-band wireless communication path, a base-band wire line communication path, or a pass-band wire line communication path. When the data path is a base-band path, filter 70 is a low pass filter and when the data path is a pass-band communication path, the filter 70 is a band-pass filter. Accordingly, the filter 70 is determining whether the characteristic of the signal present signal at point 1 is in the frequency range of a valid analog receive signal, determining whether its magnitude is of a sufficient threshold for a valid analog receive signal and/or determining whether the power level is of a valid level for the particular data transmission protocol.

The output of filter 70 is rectified by diode 72 and provided to the level detection module 74. The level detection module 74 compares the filtered and rectified analog receive signal 44 with a characteristic threshold 82. The characteristic threshold 82 may correspond to magnitude and/or power levels. Assume 4.1, that the characteristic of the filtered analog receive signal 44 exceeds the characteristic threshold 82 such that the signal present signal 54 is generated. At this point, the 3^{rd} detection module 62 is enabled.

The 3^{rd} detection module 62 includes a comparator 76, a memory 78 for storing a digital representation of the signal, and memory 80 for storing a digital representation of a startup sequence. When the signal present signal 54 is enabled, the comparator 76 is enabled. As previously discussed with reference to FIG. 2, when the signal present signal 54 is enabled, the receive path produces a digital representation of the analog receive signal 44. That digital representation is stored in memory 78. As such, the comparator 76 determining whether the digital representation of the analog receive signal 44 corresponds to the startup sequence. In this example, point 1 of FIG. 3 does not correspond to the startup sequence. As such, the 3^{rd} detection module 62 will not produce the system wakeup signal 68.

As the energy in the analog receive signal 44 dissipates from point 1, the charge across capacitor 86 will be dissipated through resistor 88. As such, the enable signal 52 will be de-asserted thus deactivating the 2^{nd} detection module 24. The 2^{nd} detection module 24 will remain deactivated until the analog receive signal 44 reaches point 2. At this point in time, the energy of the analog receive signal 44 at point 2 is sufficient to cause the 1^{st} detection module 22 to produce the enable signal 52. At point 2, the 2^{nd} detection module 24 determines that the characteristics of the signal at point 2 do not exceed the characteristic threshold 82. As such, the 2^{nd} detection module 24 does not produce the signal present signal 54. As such, the 3^{rd} detection module 64 remains disabled.

The analog front-end remains disabled until the analog receive signal reaches point 3. At point 3, the 1^{st} detection module 22 produces the enable signal 52. Since the magnitude and/or power of the analog receive signal 44 at point 3 exceeds the characteristic threshold 82, a 2^{nd} detection module 24 produces the signal present signal 54. As such, the 3^{rd} detection module 62 is enabled. As previously mentioned, once the signal present signal 54 is enabled, the analog to digital converter of the received path produces a digital representation of the analog receive signal. This digital representation is stored in memory 78 and compared with a startup sequence stored in memory 80. As one of average skill in the art will appreciate, there is a multitude of ways in which an incoming signal can be compared to a reference signal. At point 3, the analog receive signal is the beginning of the startup sequence. As such, comparator 76 generates the system wakeup signal 68. At this point, the analog front-end is completely awakened to begin transmitting a communication.

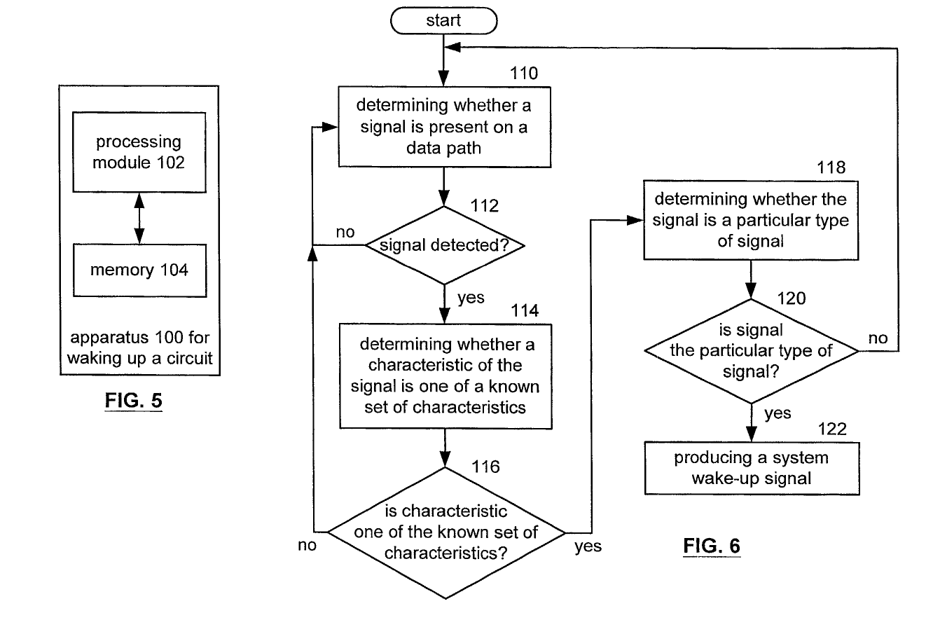

FIG. 5 illustrates a schematic block diagram of an apparatus 100 for waking up the circuit. The apparatus 100 includes a processing module 102 and memory 104. The processing module 102 may be a single processing device or a plurality or processing devices. Such a processing device may be a microprocessor, microcontroller, digital signal processor, central processing unit, state machine, logic circuitry, and/or any device that manipulates signals (analog or digital) based on operational instructions. The memory 104 may be a single memory device or a plurality of memory devices. Such a memory device may be a read-only memory, random access memory, system memory, flash memory, and/or any device that stores digital information. Note that when the processing module 102 implements one or more of its functions via a state machine or logic circuitry, the memory storing the corresponding operational instructions is embedded within the circuitry comprised in the state machine or logic circuit. The operational instructions stored in memory 104 and executed by processing module 22 are illustrated in the logic diagrams shown in FIGS. 6 through 9.

FIG. 6 illustrates a logic diagram of a method for waking up a circuit. The process begins at Step 110 where a process is initiated to determine whether a signal is present on a data path. The process then proceeds to Step 112 where determination is made as to whether the signal was detected. If not, the processor remains in a loop of Steps 110 and 112. If a signal is detected, the process proceeds to Step 114 where a process is initiated to determine whether a characteristic of the signal is one of a known set of characteristics. The known set of characteristics includes frequency, phase, amplitude, energy power levels, and/or any other characteristic that a telecommunication signal may have. The process then proceeds to Step 116 where determination is made as to whether the characteristic is one of the known set of characteristics. If no, the process repeats at Step 110.

If the characteristic is one of the known sets of characteristics, the process proceeds to Step 118. At Step 118, a process is initiated to determine whether the signal is of a particular type of signal. For instance, the particular type of signal corresponds to the data transmission protocol being utilized. If the data transmission protocol is ADSL or SHDSL, the particular type of signal corresponds to a pre-training sequence used in such data transmission protocols. The process then proceeds to Step 120 where determination is made as to whether the signal is the particular type of signal. If not, the process reverts to Step 110. If so, the process proceeds to Step 122 where a system wakeup signal is produced.

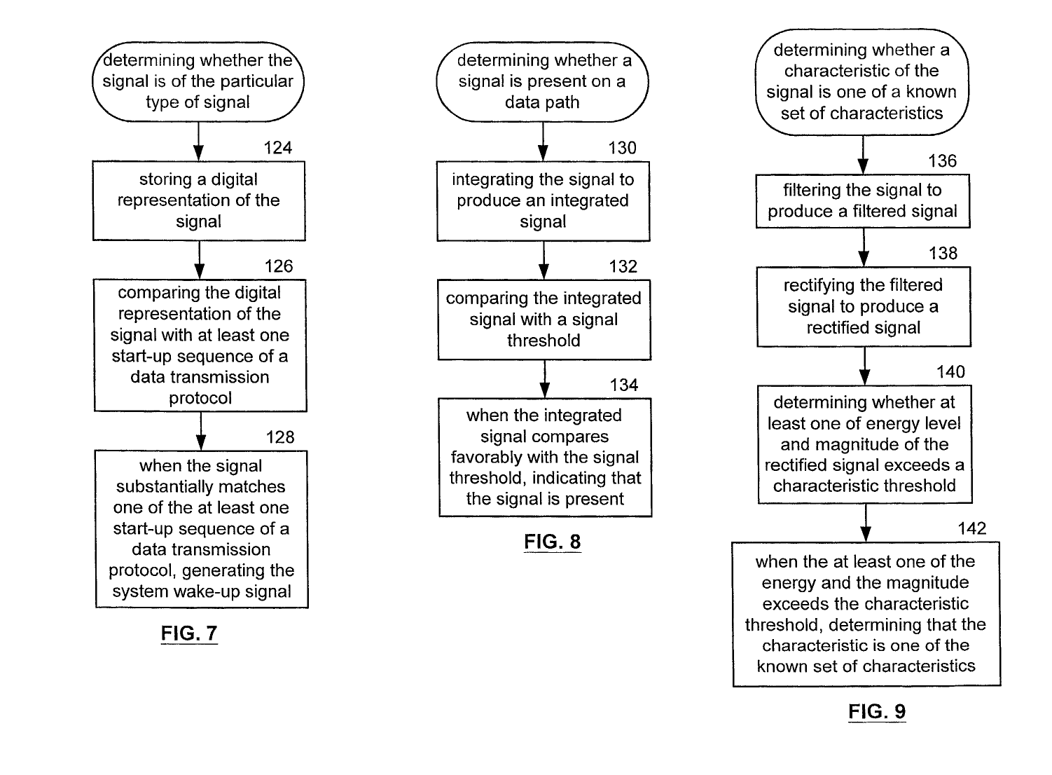

FIG. 7 illustrates a logic diagram for further describing the process of determining whether the signal is of a particular type of signal. The process begins at Step 124 where a digital representation of the signal is stored. The process then proceeds to Step 126 where the digital representation of the signal is compared with at least one startup sequence of a data transmission protocol. The process then proceeds to Step 128 where, when the signal substantially matches one of the at least one startup sequences of a data transmission protocol, the system wakeup signal is generated.

FIG. 8 illustrates a logic diagram further describing the processing of determining whether a signal is present on a data path. Such processing begins at Step 130 where the signal is integrated to produce an integrated signal. Note that before the signal is integrated, it should be rectified. The process then proceeds to Step 132 where the integrated signal is compared with a signal threshold. The process then proceeds to Step 134 where when the integrated signal compares favorably with the signal threshold, the enable signal is generated.

FIG. 9 illustrates a logic diagram of further processing to determine whether a characteristic of the signal is one of a known set of characteristics. The processing begins at Step 136 where the signal is filtered to produce a filtered signal once an enable signal is present. The process then proceeds to Step 138 where the filtered signal is rectified to produce a rectified signal. The process then proceeds to Step 140 where a determination is made as to whether at least one of the energy level or the magnitude of the rectified signal exceeds a characteristic threshold. The process then proceeds to Step 142 where, when at least one of the energy level or the magnitude of the rectified signal exceeds the characteristic threshold, the signal is determined to have the characteristic that is within the known set of characteristics.

The preceding discussion has presented a method and apparatus and applications thereof for an extremely low power wakeup circuit. By including multiple stages of wakeup, the 1^{st} stage can be implemented utilizing passive components and powered from the energy received via the incoming signal. As such, negligible power is consumed by the wakeup circuit until some type of signal is present on the incoming path. The system progressively wakes up as the signal detected on the path becomes more and more likely that it is representative of an actual telecommunication transmission. As one of average skill in the art will appreciate, other embodiments may be derived from the teachings of the present invention without deviating from the scope of the claims.

What is claimed is:

1. A wake up circuit comprises:
first detection module operably coupled to a data path to determine whether a signal is present on the data path, wherein, when the signal is detected on the data path, the first detection module produces an enable signal; and
second detection module operable based on the enable signal, wherein, when the enable signal is produced, the second detection module is operably coupled to determine whether a characteristic of the signal is one of a known set of characteristics, wherein, when the characteristic is one of the known set of characteristics, the second detection module provides a signal present signal, and wherein the second detection module is inoperable when the enable signal is not produced.

2. The wake up circuit of claim 1 further comprises:
a third detection module operable based on the signal present signal, wherein, when the signal present signal is produced, the third detection module is operably coupled to determine whether the signal is a particular type of signal, wherein, when the signal is the particular type of signal, the third detection module produces a system wake-up signal, and wherein the third detection module is inoperable when the signal present signal is not produced.

3. The wake up circuit of claim 2, wherein the third detection module further comprises:
first memory for storing a digital representation of the signal;
second memory for storing at least one start-up sequence of a data transmission protocol; and
comparator operably coupled to compare the digital representation of the signal with the at least one start-up sequence of a data transmission protocol, wherein, when the signal substantially matches one of the at least one start-up sequence of a data transmission protocol, the comparator generates the system wake-up signal.

4. The wake up circuit of claim 1, wherein the first detection module comprises:
diode having an anode and a cathode, wherein the anode is operably coupled to receive the signal;
capacitor having a first plate and a second plate, wherein, the first plate is coupled to the cathode and the second plate is coupled to a reference potential;
first resistor coupled in parallel with the capacitor;
transistor having a gate, drain, and source, wherein the gate is coupled to the cathode and the source is coupled to the reference potential;
inverter having an input and an output, wherein the input is coupled to the drain and the output provides the enable signal; and
second resistor operably coupled to the input of the inverter and to a source potential.

5. The wake up circuit of claim 1, wherein the second detection module comprises:
filter operably coupled to filter the signal to produce a filtered signal;
rectifier operably coupled to rectify the filtered signal to produce a rectified signal; and
level detection module operably coupled to determine whether at least one of energy level and magnitude of the rectified signal exceeds a characteristic threshold, such that when the at least one of the energy and the magnitude exceeds the characteristic threshold, the characteristic is one of the known set of characteristics.

6. The wake up circuit of claim 5, wherein the data path comprises at least one of:
base band wireless communication path;
pass band wireless communication path;
base band wire line communication path; and
pass band wire line communication path.

7. The wake up circuit of claim 6, wherein the filter further comprises:
band pass filter when the data path is the pass band wireless communication path or the pass band wire line communication path; and
low pass filter when the data path is the base band wireless communication path or the base band wire line communication path.

8. An analog front end comprises:
transmit path that includes:
digital to analog converter operably coupled to convert a digital transmit signal into an analog transmit signal;
line driver operably coupled to amplify energy of the analog transmit signal to produce an amplified analog transmit signal;
receive path that includes:
filter having an input and an output, wherein the input is operably coupled to receive an analog receive signal, wherein the filter filters and amplifies the analog receive signal to produce a filtered analog receive signal;
oversampling quantizer operably coupled to convert the filtered analog receive signal into a stream of digital data;
decimation filter operably coupled to decimate the stream of digital data into a digital receive signal;
wake up circuit operably coupled to disable the digital portions of the transmit and receive paths until a viable analog receive signal is detected, the wake up circuit includes:
first detection module operably coupled to determine whether a signal is present at the input of the filter, wherein, when the signal is detected at the input of the filter, the first detection module produces an enable signal; and
second detection module operable based on the enable signal, wherein, when the enable signal is produced, the second detection module is operably coupled to determine whether a characteristic of the signal is one of a known set of characteristics of the analog receive signal, wherein, when the characteristic is one of the known set of characteristics, the second detection module provides a signal present signal, and wherein at least some of the digital portions of the transmit and receive paths are enabled based on the signal present signal.

9. The analog front end of claim 8 further comprises:
digital signal processor that processes the digital receive signal and the digital transmit signal based on a data transmission protocol, wherein the digital signal processor is disabled until activation of a system wake-up signal; and
a third detection module operable based on the signal present signal, wherein, when the signal present signal is produced, the third detection module is operably coupled to determine whether the digital receive signal is a particular type of signal, wherein, when the digital receive signal is the particular type of signal, the third detection module produces a system wake-up signal, and wherein the third detection module is inoperable when the signal present signal is not produced.

10. The analog front end of claim 9 further comprises the second detection module is operably coupled to the analog to digital converter and the decimation filter, wherein, when the signal present signal is generated, the analog to digital converter and the decimation filter are enabled.

11. The analog front end of claim 9, wherein the third detection module further comprises:
first memory for storing a digital representation of the signal;
second memory for storing at least one start-up sequence of a data transmission protocol; and
comparator operably coupled to compare the digital representation of the signal with the at least one start-up sequence of a data transmission protocol, wherein, when the signal substantially matches one of the at least one start-up sequence of a data transmission protocol, the comparator generates the system wake-up signal.

12. The analog front end of claim 8, wherein the first detection module comprises:
diode having an anode and a cathode, wherein the anode is operably coupled to receive the signal;
capacitor having a first plate and a second plate, wherein, the first plate is coupled to the cathode and the second plate is coupled to a reference potential;
first resistor coupled in parallel with the capacitor;
transistor having a gate, drain, and source, wherein the gate is coupled to the cathode and the source is coupled to the reference potential;
inverter having an input and an output, wherein the input is coupled to the drain and the output provides the enable signal; and
second resistor operably coupled to the input of the inverter and to a source potential.

13. The analog front end of claim 8, wherein the second detection module comprises:
filter operably coupled to filter the signal to produce a filtered signal;
rectifier operably coupled to rectify the filtered signal to produce a rectified signal; and
level detection module operably coupled to determine whether at least one of energy level and magnitude of the rectified signal exceeds a characteristic threshold, such that when the at least one of the energy and the magnitude exceeds the characteristic threshold, the characteristic is one of the known set of characteristics.

14. A method for waking up a circuit, the method comprises the steps of:
determining whether a signal is present on a data path;
when the signal is detected on the data path, determining whether a characteristic of the signal is one of a known set of characteristics;
when the characteristic is one of the known set of characteristics, determining whether the signal is a particular type of signal; and
when the signal is the particular type of signal, producing a system wake-up signal.

15. The method of claim 14, wherein the determining whether the signal is of the particular type of signal further comprises:
storing a digital representation of the signal;
comparing the digital representation of the signal with at least one start-up sequence of a data transmission protocol; and
when the signal substantially matches one of the at least one start-up sequence of a data transmission protocol, generating the system wake-up signal.

16. The method of claim 14, wherein the determining whether a signal is present on a data path further comprises:
integrating the signal to produce an integrated signal; and
comparing the integrated signal with a signal threshold;
when the integrated signal compares favorably with the signal threshold, indicating that the signal is present.

17. The method of claim 14, wherein the determining whether a characteristic of the signal is one of a known set of characteristics further comprises:
filtering the signal to produce a filtered signal;
rectifying the filtered signal to produce a rectified signal;
determining whether at least one of energy level and magnitude of the rectified signal exceeds a characteristic threshold; and
when the at least one of the energy and the magnitude exceeds the characteristic threshold, determining that the characteristic is one of the known set of characteristics.

18. An apparatus for waking up a circuit, the apparatus comprises:
processing module; and
memory operably coupled to the processing module, wherein the memory stores operational instructions that cause the processing module to:
determine whether a signal is present on a data path;
when the signal is detected on the data path, determine whether a characteristic of the signal is one of a known set of characteristics;
when the characteristic is one of the known set of characteristics, determine whether the signal is a particular type of signal; and
when the signal is the particular type of signal, produce a system wake-up signal.

19. The apparatus of claim 18, wherein the memory further comprises operational instructions that cause the processing module to determine whether the signal is of the particular type of signal by:
storing a digital representation of the signal;
comparing the digital representation of the signal with at least one start-up sequence of a data transmission protocol; and
when the signal substantially matches one of the at least one start-up sequence of a data transmission protocol, generating the system wake-up signal.

20. The apparatus of claim 18, wherein the memory further comprises operational instructions that cause the processing module to determine whether a signal is present on a data path by:
integrating the signal to produce an integrated signal; and
comparing the integrated signal with a signal threshold;
when the integrated signal compares favorably with the signal threshold, indicating that the signal is present.

21. The apparatus of claim 18, wherein the memory further comprises operational instructions that cause the processing module to determine whether a characteristic of the signal is one of a known set of characteristics by:
filtering the signal to produce a filtered signal;
rectifying the filtered signal to produce a rectified signal;
determining whether at least one of energy level and magnitude of the rectified signal exceeds a characteristic threshold; and
when the at least one of the energy and the magnitude exceeds the characteristic threshold, determining that the characteristic is one of the known set of characteristics.
